(19) United States
(12) Patent Application Publication
(10) Pub. No.: US 2012/0282165 A1
(43) Pub. Date: Nov. 8, 2012

(54) PROCESSES FOR THE FLUX CALCINATION PRODUCTION OF TITANIUM DIOXIDE

(75) Inventor: CARMINE TORARDI, Wilmington, DE (US)

(73) Assignee: E. I. DU PONT DE NEMOURS AND COMPANY, Wilmington, DE (US)

(21) Appl. No.: 13/286,088

(22) Filed: Oct. 31, 2011

Related U.S. Application Data
(63) Continuation-in-part of application No. 12/521,000, filed on Jun. 24, 2009, now abandoned.
(60) Provisional application No. 60/882,338, filed on Dec. 28, 2006.

(51) Int. Cl. C01G 23/053

(52) U.S. Cl. 423/610

(57) ABSTRACT

Processes for the production of euhedral rutile titanium dioxide from titanyl hydroxide using calcination with a flux are provided. Calcination in the presence of sodium chloride flux has been found to lower the calcination temperature used to produce the rutile form of titanium dioxide and to improve control of particle size.

### CROSS REFERENCE TO RELATED APPLICATIONS

This application claims the benefit, under 35 U.S.C. §120, of co-pending U.S. patent application Ser. No. 12/521,000, filed Dec. 26, 2007.

### FIELD OF THE INVENTION

The present invention relates to processes for the production of euhedral rutile titanium dioxide from titanyl hydroxide using calcination with a flux. Titanium dioxide, particularly the rutile phase, is used as a white pigment in paints and plastics.

### BACKGROUND

Titanyl hydroxide can be produced by two major processes, chloride and sulfate. Calcination of titanyl hydroxide in the presence of sodium salts can be used to produce the rutile form of titanium dioxide.

Robert (U.S. Pat. No. 5,494,652) discloses a process reacting tin oxide with an alkali metal halide at 400 to 1200° C.

There remains a need for processes to produce pigmentary-sized euhedral rutile titanium dioxide.

### SUMMARY OF THE INVENTION

One aspect of the present invention is a process for producing euhedral rutile titanium dioxide comprising:

a) forming a calcination mixture consisting essentially of sodium chloride and titanyl hydroxide;

b) heating the mixture to a target temperature of 750 to 850° C. to form a mixture of rutile titanium dioxide and sodium chloride; and

c) optionally, separating the sodium chloride from the rutile titanium dioxide.

In some embodiments, the target temperature is reached within a time period of about 0.5 hours to about 48 hours.

In some embodiments, the mixture is held at the target temperature for up to 72 hours.

### BRIEF DESCRIPTION OF THE FIGURES

FIG. 1 (a) is a scanning electron micrograph of irregularly-shaped particles with a size range of about 50 to 300 nm.

FIG. 1 (b) is a scanning electron micrograph of well-shaped particles with a size range of about 200 to 800 nm, and illustrates how NaCl can serve as a size and shape control agent.

FIG. 2 (a) is a scanning electron micrograph showing media-milled product mainly of 20-100 nm irregularly-shaped particles.

FIG. 2 (b) is a scanning electron micrograph showing media-milled product of well-shaped primary particles in the range of about 100-500 nm.

FIG. 3 is a scanning electron micrograph of particles from Example 7, Experiment 22.

FIG. 4 is a graph of the particle size distribution of particles made by the process described in Example 8, in which the target temperature was 800° C.

FIG. 5 is a graph of the particle size distribution of particles made by the process described in Example 8, in which the target temperature was 850° C.

FIG. 6 is a scanning electron micrograph of particles of Sample 106M, from Example 8.

FIG. 7 is a scanning electron micrograph of particles of Sample 106L, from Example 8.

### DETAILED DESCRIPTION

Disclosed herein is a calcination process using a sodium chloride flux for the production of titanium dioxide. The process is especially useful for producing euhedral, pigmentary-sized rutile, which is used in many large-scale commercial applications. “Euhedral” particles have well-formed and well-defined crystal boundaries, i.e., most of the edges are straight lines.

Reaction temperatures in the flux calcination crystallization process range from 750° C. up to 850° C. Reaction times range from a fraction of a minute to three days. Generally, higher temperatures favor the formation of rutile over anatase. Higher temperatures also tend to result in the formation of larger particles, which are less desirable as pigments due to decreased scattering efficiency. Rutile titanium dioxide primary particles of 100-600 nm are generally preferred. Varying the process conditions, such as time at temperature, can be used to selectively control the resulting titanium dioxide particle size and morphology. Less time at temperature favors the formation of smaller average sized particles.

In addition to the advantage of being able to produce rutile at lower temperature, calcinations conducted according to the processes of this invention tend to favor the formation of primary particles and minimize the production of aggregated (fused) particles.

Sodium chloride typically comprises 1-50 wt %, or 1-30 wt %, or 1-10 wt %, or 3-100 wt %, or 3-60 wt %, or 3-40 wt %, or 3-50 wt %, or 3-40 wt %, or 5-40 wt % of the calcination mixture, based on the weight of dry TiO₂ equivalent in the titanyl hydroxide.

Titanyl hydroxide can be produced by either of the known commercial processes for titanium dioxide production, the chloride process or the sulfate process. Titanyl hydroxide can also be produced by other known processes, such as extraction of titanium-rich solutions from digestion of ilmenite by oxalic acid, ammonium hydrogen oxalate, or trimethylammonium hydrogen oxalate, followed by hydrolysis. Although the titanyl hydroxide can comprise minor amounts of other inorganic compounds, such as the sulfates, phosphates or chloride residues form the above-mentioned commercially practiced sulfate and chloride processes for the production of titanium dioxide, the wt % of such inorganic compounds should be less than 0.5 wt %, or less than 0.3 wt %, or less than 0.1 wt % of the dry weight of the calcination mixture.

In particular, it has been found that minimizing the amount of oxy-compounds of phosphorus minimizes the formation of acicular TiO₂ particles.

After mixing the titanyl hydroxide with sodium chloride, the resulting mixture is heated to a target temperature of 750 to 850° C., or 750 to 800° C., or 800 to 850° C. to form euhedral rutile titanium dioxide particles, mixed with sodium chloride. In some embodiments, the heating to a target temperature is carried out over a time period of about 0.5 hours to about 48 hours. In some embodiments, the mixture is held at the target temperature for up 72 hours. If desired, the amount of sodium chloride in the product can be reduced by washing.

Calcination of titanyl hydroxide by the process of this invention produces euhedral rutile titanium dioxide, even in the absence of seed crystals of rutile.

The processes disclosed herein can produce euhedral pigmentary-sized rutile titanium dioxide. An average particle diameter of 100 nanometers is usually used to distinguish nano-sized titanium dioxide from pigmentary-sized titanium dioxide. An average particle size of 100 nanometers is at the low end of the size range of pigmentary titanium dioxide supplied by the existing commercial processes. Smaller particle diameters are referred to as nano-sized titanium dioxide. Pigmentary-sized particles have a large market and thus are frequently the desired particle size.

Titanium dioxide is frequently supplied to the pigment market with a coating such as silica or alumina which can be added in an additional process step after calcination.

### EXAMPLES

### Example 1

This example illustrates the use of NaCl to control the morphology of rutile.

Ammonium titanyl oxalate (ATO, 96.0 g, Aldrich 99.998) was dissolved in 400 mL deionized water and the resulting mixture was filtered to remove undissolved solids. The filtered solution was transferred to a jacketed Pyrex round-bottomed flask equipped with a water-cooled condensor and heated to 90° C. with stirring using a Teflon®-coated stirring bar. A solution consisting of 1 part concentrated NH₄OH and 1 part deionized water by volume was added dropwise to the ATO solution until a pH of 7.5 was attained. The white slurry was stirred at 90° C. for 15 minutes, after which time it was transferred to a jacketed filter and filtered at 90° C. The filter cake was washed several times with water heated to 90° C. until the filtrate had a conductivity of about 500 microSiemens. A small portion of the washed cake was dried in air at room temperature. X-ray powder diffraction showed the dried sample to be nanocrystalline anatase.

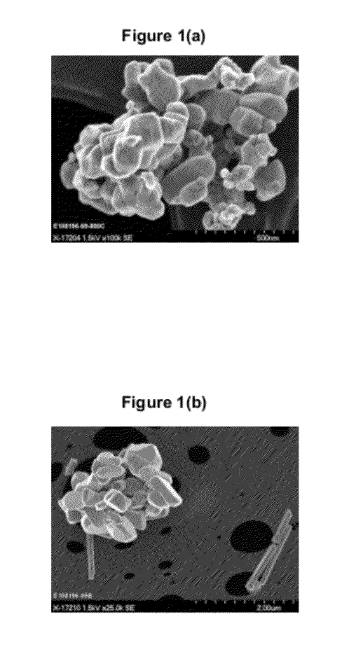

Another portion of dried sample was heated in air from room temperature to 800° C. over a time period of 3 hours, and held at 800° C. for 1 hour. XPD showed the fired product to consist of 99% rutile and 1% anatase. A scanning electron micrograph of this sample (FIG. 1(a)) shows irregularly-shaped particles with a size range of about 50 to 300 nm.

Another portion of dried sample was mixed with NaCl by grinding in a mortar. The amount of NaCl was 5 wt %, based on the weight of dry TiO₂. The mixture was heated in air from room temperature to 800° C. over a time period of 3 hours, and held at 800° C. for 1 hour. XPD showed the fired product to consist mainly of rutile with a trace of Na₂Ti₆O₁₃. No anatase was found. A scanning electron micrograph of this sample (FIG. 1(b) shows well-shaped particles with a size range of about 200 to 800 nm, and illustrates how NaCl can serve as a size and shape control agent.

Another portion of dried sample was mixed with NaCl by grinding in a mortar. The amount of NaCl was 5 wt % based on the weight of dry TiO₂. The mixture was heated in air from room temperature to 850° C. over a time period of 3 hours, and held at 850° C. for 1 hour. XPD showed the fired product to consist mainly of rutile with a trace of Na₂Ti₆O₁₃. No anatase was found.

### Example 2

This example illustrates the use of NaCl as a rutile promoter.

Samples of titanyl hydroxide (2.5 g each), derived from an oxalate process leachate and containing about 0.5 g TiO₂ on a dry basis, were heated with NaCl (5 wt % and 33 wt % on TiO₂), and with AlCl₃.6H₂O (1 wt % Al₂O₃ on TiO₂), as described in Table 1 below, in an alumina crucible from room temperature to 90° C. over a 1 hour period and held at 90° C. for 4 hours at which time the temperature was increased to 850° C. over a 3 hour period, and held at 850° C. for 1 hour. Results of X-ray powder diffraction analyses are given in Table 1 and indicate that NaCl greatly assists the formation of rutile, while in the absence of NaCl, anatase is the predominant product. The results also show addition of aluminum chloride counteracts the sodium chloride and stabilizes anatase.

TABLE 1
Effect of NaCl and AlCl₃•6H₂O on TiO₂ Product

| | A | B | C | D | E |
|---|---|---|---|---|---|
| Ingredient | (g) | (g) | (g) | (g) | (g) |
| Ti-ppt | 2.5 | 2.5 | 2.5 | 2.5 | 2.5 |
| NaCl | — | 0.025 | 0.167 | 0.025 | 0.167 |
| AlCl₃•6H₂O | — | — | — | 0.024 | 0.024 |
| H₂O | 1 | 1 | 1 | 1 | 1 |
| Product | anatase | anatase + | ~98% | anatase | anatase |
| | | tr. | rutile ~2% | | |
| | | Na₂Ti₆O₁₃ | anatase + | | |
| | | | tr. | | |
| | | | Na₂Ti₆O₁₃ | | |

The reaction of Example 2C was repeated without the initial four hour heating at 90° C. and the reaction mixture was heated from room temperature to 850° C. over a 3 hour period and held at 850° C. for 1 hour. From XPD, the product was identified as mainly rutile, with traces of anatase and Na₂Ti₆O₁₃.

### Example 3

This example illustrates the use of NaCl as a rutile promoter.

A portion of titanyl hydroxide, derived from an oxalate process leachate, was dried in air at room temperature and used for experiments 3A and 3B (Table 2). Samples (0.6 g each), containing about 0.5 g TiO₂ on a dry basis, were ground together with NaCl (5 wt % and 33 wt % NaCl based on TiO₂) and heated in alumina crucibles from room temperature to 850° C. over a 3 hour period, and held at 850° C. for 1 hour. Results of X-ray powder diffraction analyses are given in Table 2 and indicate that NaCl greatly assists the formation of rutile.

TABLE 2
Effect of NaCl as Rutile Promoter

| | A | B |
|---|---|---|
| Ingredient | (g) | (g) |
| Ti-ppt | 0.6 | 0.6 |
| NaCl | 0.025 | 0.167 |
| Product | ~1:1 | essentially all |
| | rutile:anatase, | rutile, with tr. |
| | with tr. Na₂Ti₆O₁₃ | Na₂Ti₆O₁₃ |

### Example 4

This example shows that NaCl is a rutile promoter when particle size control additives used in the sulfate process are also present.

A portion of titanyl hydroxide, derived from an oxalate process leachate, was dried in air at room temperature and used for experiments Example 4A and Example 4B. Samples (0.6 g each), containing about 0.5 g TiO₂ on a dry basis, were ground together with 0.0005 g Na₂SO₄, 0.0025 g K₂SO₄, 0.0024 g, NH₄H₂PO₄, and 0.025 g rutile seed. NaCl (0.025 g, 5 wt %) was added to sample B and both samples were heated in alumina crucibles from room temperature to 800° C. over a 3 hour period, and held at 800° C. for 1 hour. Results of X-ray powder diffraction analyses are given in Table 3 and indicate that NaCl greatly assists the formation of rutile.

TABLE 3
Effect of other morphology control additives

| | Example 4A | Example 4B |
|---|---|---|
| Product | Mainly anatase, | 60% rutile, 40% |
| | with v. small | anatase |
| | amount of rutile | |

### Example 5

This example illustrates the use of NaCl to control the morphology of rutile.

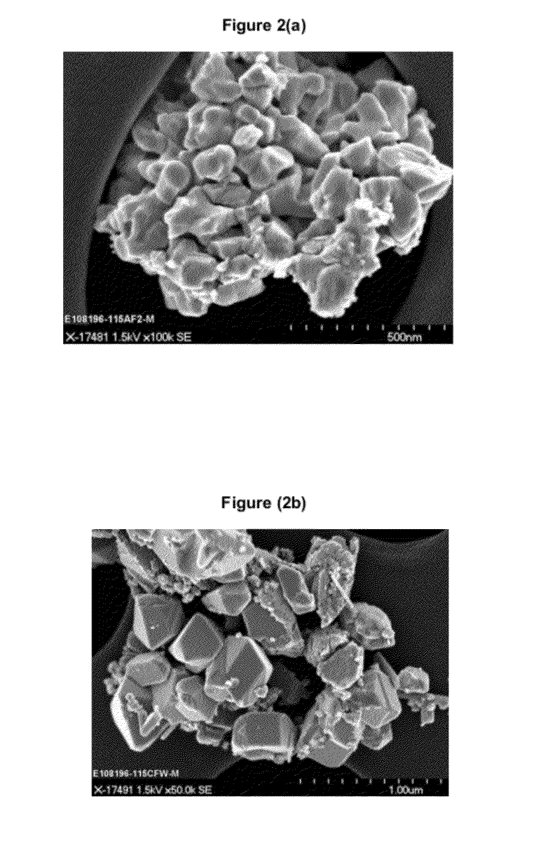

Ammonium titanyl oxalate (ATO, 36.8 g, Aldrich 99.998), was dissolved in 300 mL deionized water and the resulting mixture was filtered to remove undissolved solids. The filtered solution was transferred to a Pyrex® beaker and stirred with a Teflon®-coated stirring bar. Concentrated NH₄OH was added dropwise to the ATO solution until a pH of 9 was attained. The white slurry was filtered immediately and the filter cake was washed with 400 mL deionized water at room temperature. The Ti-containing cake was transferred to a beaker and 450 mL concentrated NH₄OH were added and the mixture was stirred and boiled for 30 minutes. The precipitate filtered rapidly. The Ti cake was again transferred to a beaker and reslurried with concentrated NH₄OH, then boiled for 30 minutes. After collecting the solids on a filter, the cake was transferred to a beaker, slurried with about 450 mL deionized water, stirred for one day at room temperature, then boiled for one hour. After collecting the solids, the washed cake was dried in air under IR heat (−40° C.). The entire sample was heated to 800° C. over a period of three hours, and held at 800° C. for three hours. An X-ray powder diffraction pattern of the fired product showed it to be mainly rutile with a trace of anatase. Scanning electron microscopy imaging showed media-milled product to consist mainly of 20-100 nm irregularly-shaped particles as shown in FIG. 2(a).

Ti-precipitate cake was made as described above, but before drying the washed cake under IR heat, 3.32 g NaCl, dissolved in 10 mL H₂O, were mixed into the TiO₂ cake. The entire sample was heated to 800° C. over a period of three hours, and held at 800° C. for one hour. An X-ray powder diffraction pattern of the fired product showed it to be 95% rutile and 5% anatase. Scanning electron microscopy imaging showed media-milled product to consist of well-shaped primary particles in the range of about 100-500 nm and some small, <100 nm, irregularly-shaped particles as shown in FIG. 2(b).

### Example 6

This example shows that NaCl is a rutile promoter when particle size control additives used in the sulfate process are also present, and when the mixture is heated in a rotary calciner.

Titanyl hydroxide (315 g), derived from an oxalate process leachate, containing ˜49 g TiO₂ on a dry basis, was mixed with 49 g of a solution consisting of 0.19 wt % KH₂PO₄, 0.38 wt % K₂HPO₄, and 0.09 wt % Na₂HPO₄ in H₂O, 98 g of a solution consisting of 2.4 wt % AlCl₃.6H₂O in H₂O, 49 g of a solution consisting of 4.8 wt % NaCl in H₂O, and 69 g of 2.9 wt % rutile seed suspension in aqueous HCl solution. The mixture was dried in air under IR heat (˜40° C.) and powdered in a mortar. A 55 g portion of the dried mixture was heated to 1050° C. in a fused silica rotary calciner over a period of 3 hours and held at 1050° C. for 8 hours. An XPD pattern of the product showed it to be all rutile.

A 2.5 g portion of the dried mixture prepared as described above was fired in an alumina crucible to 1050° C. over a 12 hour period, at which point power to the furnace was removed and the sample was allowed to cool naturally to room temperature. An XPD pattern of the product showed it to be rutile, with a trace of Na₂Ti₆O₁₃.

A 2.5 g portion of the dried mixture prepared as described above was fired in an alumina crucible to 1150° C. over a 12 hour period, at which point power to the furnace was removed and the sample was allowed to cool naturally to room temperature. An XPD pattern of the product showed it to be all rutile.

### Example 7

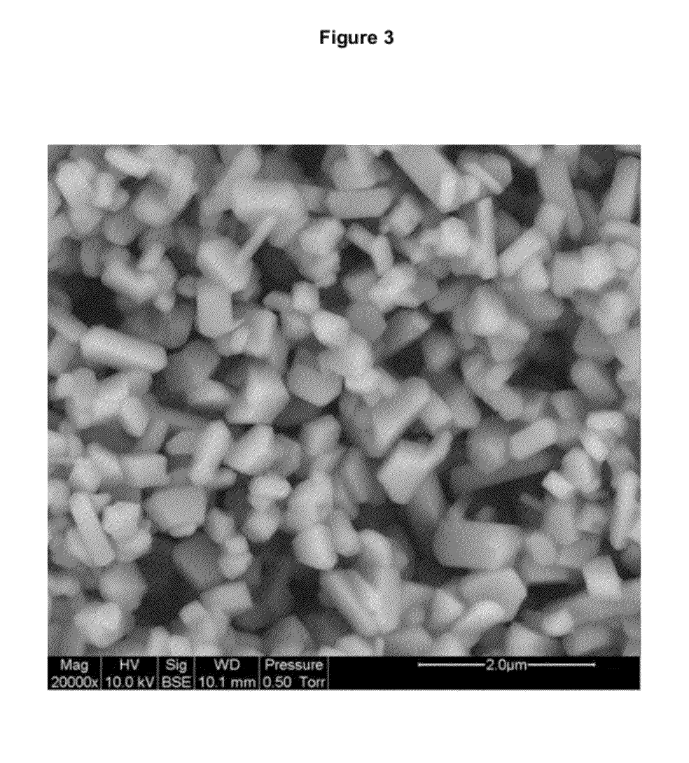

Titanyl hydroxide, derived from an oxalate process leachate, was washed with water at room temperature to remove NH₄OH via cycles of stirring and centrifuging until the pH was about 7-8. The slurry used for the experiments contained 13.18 wt % TiO₂, as shown in Table 4. Phosphate, potassium and sodium additives were mixed with the titanyl hydroxide as indicated in Table 4. Sodium chloride flux was added to some of the mixtures. When sodium chloride was present, a greater amount of rutile was observed at the lower target temperatures, showing that NaCl is a good rutile promoter. FIG. 3 is an SEM of a portion of the product, and shows that NaCl was a particle morphology control agent at 800° C.

TABLE 4
Effect of various additives on the formation of rutile

| | g of Washed | | | | | Ramp-up | | Hold | | |
|---|---|---|---|---|---|---|---|---|---|---|
| | Oxalate Process | g of 0.48 | g of 0.43 | g of 0.07 | g of 3.0 | time (hrs) | | Time (hrs) | | |
| Experiment | Leachate Ti-ppt., | wt % H3PO4 | wt % KCl | wt % NaCl | wt % NaCl | to Target | Target | at Target | % | % |
| No. | 13.2 wt % TiO2 | Solution | Solution | Solution | Solution | Temp | Temp ° C. | Temp | Rutile | Anatase |
| 1 | 15.2 | 1 | 3 | 1 | 2 | 5 | 1050 | 4 | 100 | 0 |
| 2 | 15.2 | 3 | 1 | 3 | 0 | 5 | 1050 | 4 | 99 | 0 |
| 3 | 15.2 | 1 | 3 | 3 | 2 | 5 | 850 | 0 | 60 | 40 |
| 4 | 15.2 | 3 | 1 | 1 | 0 | 5 | 850 | 0 | 0 | 100 |
| 5 | 15.2 | 3 | 1 | 3 | 2 | 5 | 1050 | 0 | 100 | 0 |
| 6 | 15.2 | 1 | 3 | 1 | 0 | 5 | 1050 | 0 | 96 | 4 |
| 7 | 15.2 | 1 | 1 | 1 | 2 | 15 | 1050 | 0 | 100 | 0 |
| 8 | 15.2 | 3 | 3 | 3 | 0 | 15 | 1050 | 0 | 100 | 0 |
| 9 | 15.2 | 3 | 1 | 1 | 2 | 5 | 850 | 4 | 99 | 1 |
| 10 | 15.2 | 1 | 3 | 3 | 0 | 5 | 850 | 4 | 4 | 96 |
| 11 | 15.2 | 1 | 1 | 3 | 0 | 15 | 850 | 0 | 0.5 | 99.5 |
| 12 | 15.2 | 3 | 3 | 1 | 2 | 15 | 850 | 0 | 100 | 0 |
| 13 | 15.2 | 3 | 3 | 3 | 2 | 15 | 1050 | 4 | 100 | 0 |
| 14 | 15.2 | 1 | 1 | 1 | 0 | 15 | 1050 | 4 | 100 | 0 |
| 15 | 15.2 | 1 | 1 | 3 | 2 | 15 | 850 | 4 | 100 | 0 |
| 16 | 15.2 | 3 | 3 | 1 | 0 | 15 | 850 | 4 | 3 | 97 |
| 17 | 15.2 | 1 | 0 | 3 | 0 | 15 | 800 | 0 | 0 | 100 |
| 18 | 15.2 | 1 | 1 | 3 | 3.33 | 15 | 800 | 0 | 12 | 88 |
| 19 | 15.2 | 1 | 0 | 3 | 3.33 | 15 | 850 | 0 | 100 | 0 |
| 20 | 15.2 | 1 | 0 | 3 | 0 | 15 | 800 | 0 | 0 | 100 |
| 21 | 15.2 | 1 | 1 | 3 | 3.33 | 16 | 800 | 4 | 100 | 0 |
| 22 | 15.2 | 1 | 1 | 3 | 3.33 | 1 | 800 | 4 | 100 | 0 |

### Example 8

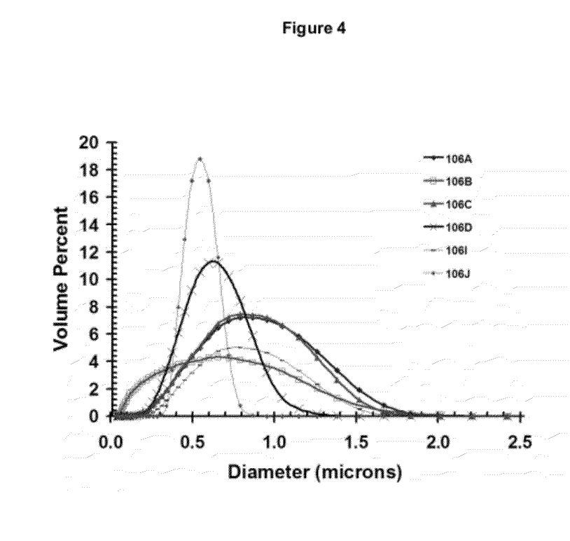

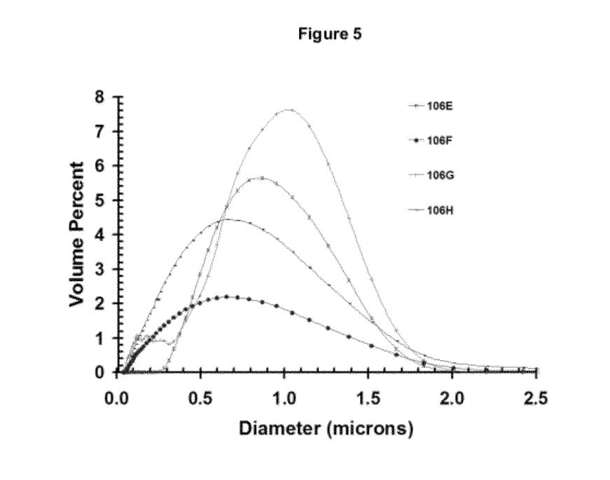

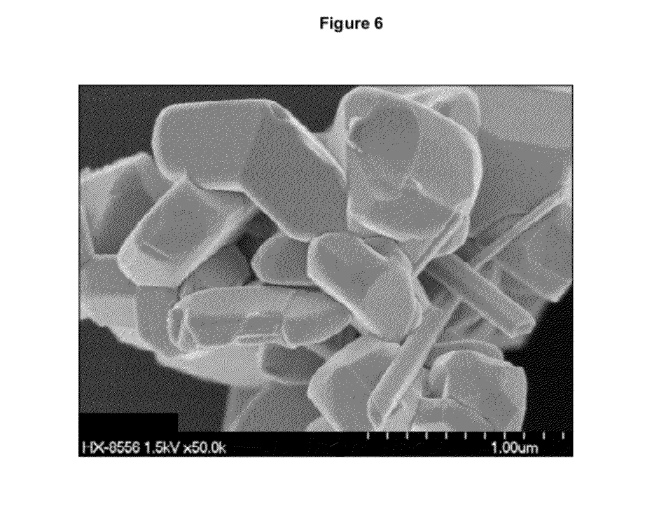

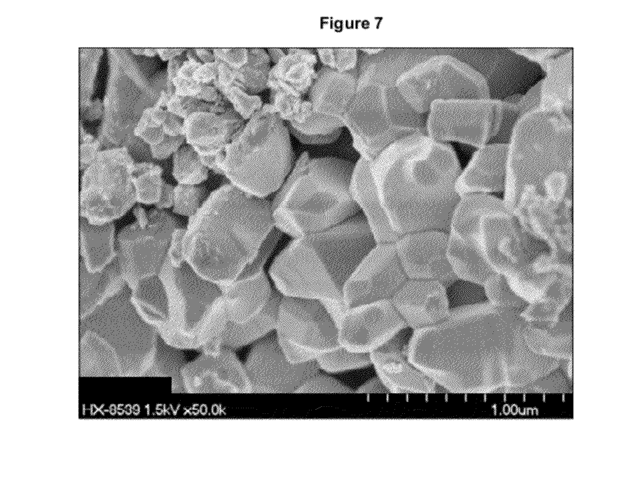

Ti-precipitate cake was prepared in a manner similar to that described in Example 1. Portions of the cake were mixed with components as described in Table 5, and calcined as described in Table 5. The particle size distributions for each sample in the range of 0-2.5 microns are shown in FIG. 4 for calcinations conducted at 800° C., and in FIG. 5 for calcinations conducted at 850° C. At each temperature, the calcinations conducted without added H₃PO₄ had the smaller average particle size, demonstrating the influence of some additives. FIGS. 6 and 7 are SEMs of portions of samples 106M and 106L, respectively.

TABLE 5
Effect of temperature and additives on the particle size

| | Reaction Components | | | | | | Furnace Conditions | | |
|---|---|---|---|---|---|---|---|---|---|
| | | | H3PO4 Soln | KCl Soln | NaCl Soln | NaCl ‘Flux’ | Ramp | Final | Hold |
| | Ti | Ti | (0.48 wt %) | (0.43 wt %) | (0.07 wt %) | (3.0 wt %) | Rate | Temp | Time |
| Sample | ppt (g) | Solids (g) | (mL) | (mL) | (mL) | (mL) | (° C./min) | (° C.) | (hr) |
| 106A | 6.85 | 0.78 | 0.39 | 0.39 | 1.171 | 1.3 | 13 | 800 | 8 |
| 106B | 6.82 | 0.78 | none | 0.389 | 1.166 | 1.295 | 13 | 800 | 8 |
| 106C | 6.88 | 0.78 | 0.392 | 0.392 | 1.176 | 1.306 | 13 | 800 | 4 |
| 106D | 6.86 | 0.78 | none | 0.391 | 1.173 | 1.302 | 13 | 800 | 4 |
| 106E | 6.83 | 0.78 | 0.389 | 0.389 | 1.168 | 1.296 | 14 | 850 | 4 |
| 106F | 6.78 | 0.77 | none | 0.386 | 1.159 | 1.287 | 14 | 850 | 4 |
| 106G | 7.00 | 0.80 | 0.399 | 0.399 | 1.197 | 1.329 | 14 | 850 | 8 |
| 106H | 6.85 | 0.78 | none | 0.39 | 1.171 | 1.3 | 14 | 850 | 8 |
| 106I | 6.81 | 0.78 | 0.388 | 0.388 | 1.165 | 1.293 | 13 | 800 | 2 |
| 106J | 6.81 | 0.78 | none | 0.388 | 1.165 | 1.293 | 13 | 800 | 2 |
| 106K | 3.93 | 0.45 | 0.224 | 0.224 | 0.672 | 0.746 | 14 | 850 | 2 |
| 106L | 4.02 | 0.46 | none | 0.229 | 0.687 | 0.763 | 14 | 850 | 2 |
| 106M | 3.96 | 0.45 | 0.677 | 0.226 | 0.677 | 0.752 | 14 | 850 | 2 |

What is claimed:

1. A process for producing euhedral rutile titanium dioxide comprising:
a) forming a calcination mixture consisting essentially of sodium chloride and titanyl hydroxide;
b) heating the mixture to a target temperature of 750 to 850° C. to form a mixture of titanium dioxide and sodium chloride; and
c) optionally, separating the sodium chloride from the titanium dioxide.

2. The process of claim 1, wherein the heating to a target is temperature over a time period of about 0.5 hours to about 48 hours.

3. The process of claim 1, wherein the mixture is held at the target temperature for up to 72 hours.

4. The process of claim 1 wherein the amount of sodium chloride is from 1 wt % to 50 wt % based on the equivalent weight of titanium dioxide in the titanyl hydroxide.

5. The process of claim 1, wherein the amount of sodium chloride is from 1 wt % to 30 wt % based on the equivalent weight of titanium dioxide in the titanyl hydroxide.

6. The process of claim 1, wherein the amount of sodium chloride is from 1 wt % to 10 wt % based on the equivalent weight of titanium dioxide in the titanyl hydroxide.

7. The process of claim 1, wherein the sodium chloride is in solid form.

8. The process of claim 1, wherein the sodium chloride is in solution.

9. The process of claim 1, wherein the mixing comprises stirring, shaking, or tumbling for several minutes up to several days.

10. The process of claim 1, wherein the titanyl hydroxide is produced from titanyl sulfate solution.

11. The process of claim 1, wherein the titanyl hydroxide is produced from titanium oxychloride solution.

12. The process of claim 1, wherein the titanyl hydroxide is is produced from ammonium titanyl oxalate solution.

13. The process of claim 1, wherein the titanyl hydroxide is produced from trimethylammonium titanyl oxalate solution.

14. The process of claim 1, wherein the sodium chloride is separated from the titanium dioxide by water washing.

15. The process of claim 1, wherein the rutile titanium dioxide has a primary particle size of 100 to 600 nm.

16. The process of claim 1, wherein the mixture is heated to a temperature of 750-850° C.

17. The process of claim 1, wherein the mixture is heated to a temperature of 750-800° C.
